(19) United States
(12) Patent Application Publication
(10) Pub. No.: US 2005/0166086 A1
(43) Pub. Date: Jul. 28, 2005

(54) Storage control apparatus, storage control method, and computer product

(75) Inventor: Takashi Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/083,964

(22) Filed: Mar. 21, 2005

Related U.S. Application Data
(63) Continuation of application No. PCT/JP02/09670, filed on Sep. 20, 2002.

(51) Int. Cl. G06F 12/16

(52) U.S. Cl. 714/6; 711/113; 711/114; 711/144

(57) ABSTRACT

A storage control apparatus that is distributed on a network with a cache device and a disk device to constitute a storage system includes a write control unit that performs a control to write data, for which the client requested to write, into a predetermined number of cache devices from among the cache devices disposed on the network in a redundant manner; and a read control unit that performs, when data, for which the client requested to read, is not stored in any cache device from among the cache devices disposed on the network, controls to read the data from the disk device, to store the data-read in a specific cache device, and to transmit the data-read to the client.

### BACKGROUND OF THE INVENTION

1) Field of the Invention

The present invention relates to a storage control apparatus, a storage control program, and a storage control method, which are used in a storage system in which a cache device and a disk device are distributed on a network, for receiving an access request from a client to make the cache device and the disk device execute a process corresponding to the access request. More particularly, the present invention relates to a storage control apparatus, a storage control program, and a storage control method that can prevent a shut down of the entire storage system resulted from a failure of an individual device, and build a storage system with higher reliability.

2) Description of the Related Art

With a recent increase of an amount of process data from a usage of multimedia data, a storage system is rapidly spreading, which integrally manages massive data using a high-capacity disk connected to a network. In this type of storage system, because a speed of accessing a disk is slower than a speed of data transfer of the network, a performance of accessing the disk is a bottleneck of the entire system. For this reason, the storage system employs a cache memory having a high access speed to improve the performance of accessing the disk by reducing the number of access to the disk.

Generally, when using a cache memory, it is necessary to use as a large size cache memory as possible because a cache hit ratio, which indicates a probability that data to be accessed is present in the cache memory, largely affects a system performance. However, in a conventional storage system, because a control of the entire storage system, a control of a disk, and a control of a cache memory are implemented as a single apparatus, it is not simple to expand a size of the cache memory. Furthermore, if a capacity of the disk is expanded by an upgrade of the storage system, a relative size of the cache memory becomes small, and as a result, the cache hit ratio becomes low.

For this reason, a distributed storage system has become popular to make it easy to expand a size of a cache memory, where a whole control of a storage system, a control of a disk, and a control of the cache memory implemented with individual devices, respectively, and the devices are distributed and connected to a network. In the distributed storage system, because only the cache memory and a control of the cache memory make an independent cache device, it is possible to expand the size of the cache memory with ease, simply by adding a cache device.

However, with the distributed storage system, each of the devices may be malfunctioning separately because each of the devices is independently disposed. Furthermore, if there is a failure in an individual network for connecting each of the devices, a corresponding device cannot be used because each of the devices is independently connected to an independent network.

In a conventional integrated storage system, it is enough to perform a redundant-array-of-independent-disks (RAID) control considering a failure of the whole storage system because the failure occurs in the whole storage system as a single system. However, in the distributed storage system, it is necessary to consider a failure in each of the individual devices distributed on the network.

The present invention is for solving the problems in the conventional technology described above. It is an object of the present invention to provide a storage control apparatus, a storage control program, and a storage control method that can prevent a shut down of the entire storage system resulted from a failure of an individual device, and build a storage system with higher reliability.

### SUMMARY OF THE INVENTION

It is an object of the present invention to solve at least the above problems in the conventional technology.

A storage control apparatus according to one aspect of the present invention, which is distributed on a network with a cache device and a disk device to constitute a storage system, receives an access request from a client, and causes the cache device and the disk device to execute a process corresponding to the access request, includes a write control unit that performs a control to write data, for which the client requested to write, into a predetermined number of cache devices from among the cache devices disposed on the network in a redundant manner; and a read control unit that performs, when data, for which the client requested to read, is not stored in any cache device from among the cache devices disposed on the network, controls to read the data from the disk device, to store the data-read in a specific cache device, and to transmit the data-read to the client.

A computer-readable recording medium according to another aspect of the present invention stores a storage control program used for a storage control apparatus that is distributed on a network with a cache device and a disk device to constitute a storage system, to receive an access request from a client, and to cause the cache device and the disk device to execute a process corresponding to the access request. The storage control program makes a computer execute a writing control including performing a control to write data, for which the client requested to write, into a predetermined number of cache devices from among the cache devices disposed on the network in a redundant manner; and a reading control including performing, when data, for which the client requested to read, is not stored in any cache device from among the cache devices disposed on the network, controls to read the data from the disk device, to store the data-read in a specific cache device, and to transmit the data-read to the client.

A storage control method according to still another aspect of the present invention, which is used for a storage control apparatus that is distributed on a network with a cache device and a disk device to constitute a storage system, to receive an access request from a client, and to cause the cache device and the disk device to execute a process corresponding to the access request, includes a writing control including performing a control to write data, for which the client requested to write, into a predetermined number of cache devices from among the cache devices disposed on the network in a redundant manner; and a reading control including performing, when data, for which the client requested to read, is not stored in any cache device from among the cache devices disposed on the network, controls to read the data from the disk device, to store the data-read in a specific cache device, and to transmit the data-read to the client.

According to the present invention, a control is performed in such a manner that data, for which the client requested to write, is written into a predetermined number of cache devices from among the cache devices disposed on the network in a redundant manner, and when data, for which the client requested to read, is not stored in any cache device from among the cache devices disposed on the network, the data is read from a disk device, to store the data-read in a specific cache device, and to transmit the data-read to the client. Therefore, it is possible to use a cache memory with efficiency, to prevent a shut down of the entire storage system resulted from a failure of an individual device, and to build a storage system with a high reliability.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic diagram for illustrating a system configuration of a storage system according to a first embodiment of the present invention;

FIG. 2 is a block diagram for illustrating a functional configuration of a storage control apparatus shown in FIG. 1;

FIG. 3 is an example of a location information table;

FIG. 4 is a block diagram for illustrating a functional configuration of a cache control apparatus shown in FIG. 1;

FIG. 5 is a schematic diagram for illustrating an example of a message transmitted from the storage control apparatus;

FIG. 6 is a schematic diagram for illustrating an example of a message transmitted from the cache control apparatus;

FIG. 7 is a schematic diagram for illustrating an example of a message transmitted from a real-disk control apparatus;

FIG. 8 is a flowchart of a process procedure for a data-write processing unit shown in FIG. 2;

FIG. 9 is a schematic diagram for explaining a method of determining a completion of a data-write into the storage system by a client;

FIG. 10 is a flowchart of a process procedure for a data-write process into a cache memory according to the first embodiment;

FIG. 11 is a flowchart of a process procedure for a data-read processing unit shown in FIG. 2;

FIG. 12 is a flowchart of a process procedure for a Fetch processing unit shown in FIG. 2;

FIG. 13 is a flowchart of a process procedure for a Flush processing unit shown in FIG. 2;

FIG. 14 is a schematic diagram for illustrating a concept of redundancy in a storage control apparatus according to a second embodiment of the present invention;

FIG. 15 a schematic diagram for illustrating a system configuration of a storage system according to the second embodiment;

FIG. 16 is a schematic diagram for illustrating an example of a location-information update message;

FIG. 17 is a flowchart of a process procedure for a location-information-table updating unit shown in FIG. 15;

FIG. 18 is a schematic diagram for illustrating an example of a modification of the redundancy in the storage control apparatus according to the second embodiment;

FIG. 19 is a schematic diagram for illustrating a system configuration of a storage system according to a third embodiment of the present invention; and

FIG. 20 is a schematic diagram for illustrating a computer system for executing a storage control program and a cache control program.

### DETAILED DESCRIPTION

Exemplary embodiments according to the present invention will be explained in detail below with reference to the accompanying drawings.

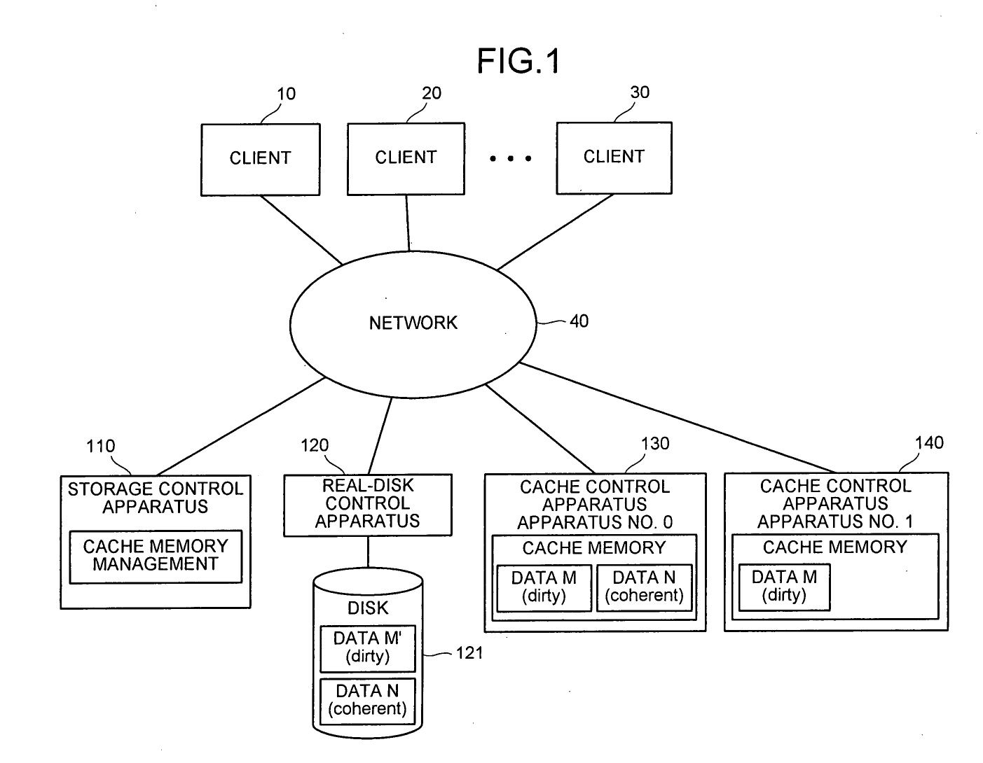

FIG. 1 is a schematic diagram for illustrating a system configuration of a storage system according to a first embodiment of the present invention. As shown in the figure, the storage system is configured by distributing a storage control apparatus 110, a real-disk control apparatus 120, and redundant cache control apparatuses 130 and 140 on a network 40, and is used by clients 10 to 30 via the network 40. Although three clients 10 to 30 are illustrated in the figure for the sake of convenience, the storage system is used by an arbitrary number of clients via the network 40. Here an explanation is given for a case when the client 10 uses the storage system, however, other clients 20 and 30 can use the storage system in the same manner.

The storage control apparatus 110 receives an access request from the client 10 via the network 40, and causes the real-disk control apparatus 120 and the cache control apparatuses 130 and 140 to execute a process corresponding to the access request. The storage control apparatus 110 manages data to be stored in a cache memory that belongs to the cache control apparatuses 130 and 140.

The real-disk control apparatus 120 includes a disk 121 as a large-capacity storage medium, and reads and writes data from and into the disk 121 based on an instruction from the storage control apparatus 110. Although there is a single real-disk control apparatus 120 shown in the figure for the sake of convenience, the storage system can employ a plurality of real-disk control apparatuses arranged on the network 40 according to a size of data to be stored. Furthermore, a plurality of disks can be connected to a single real-disk control apparatus.

The cache control apparatuses 130 and 140 includes a cache memory as a high-speed access recording medium, and reads and writes data from and into the cache memory based on an instruction from the storage control apparatus 110.

With this configuration, the storage system makes a redundant cache control apparatus to store the same data in the cache memory that belongs to the cache control apparatuses 130 and 140. However, the storage system does not make all the data redundant. When the data stored in the disk 121 is identical to the data stored in the cache memory, in other words, when the data is in a status of coherent, the data is stored in either of the cache memories. On the other hand, when the data stored in the disk 121 is different from the data stored in the cache memory, in other words, when the data is in a status of dirty, the data is stored in both cache memories.

For example, as shown in FIG. 1, because data M is changed from data M′ on the disk 121, which is in a status of dirty, the data M is stored in both cache memories of the cache control apparatuses 130 and 140. On the other hand, for data N, the same data is stored in the disk 121, the data N is stored only in the cache memory that belongs to the cache control apparatus 130.

With this mechanism, the storage system makes a redundant cache control apparatus to store the same data in two cache memories. Therefore, even when a failure has occurred in either of the cache control apparatuses 130 and 140, the storage system can be operated using the other cache control apparatus, and as a result, it is possible to implement a highly reliable storage system. Furthermore, when the data stored in the disk 121 is identical to the data stored in the cache memory, the storage system stores the data only in one of the cache memories, and as a result, it is possible to use the cache memory efficiently, and to improve the cache hit ratio.

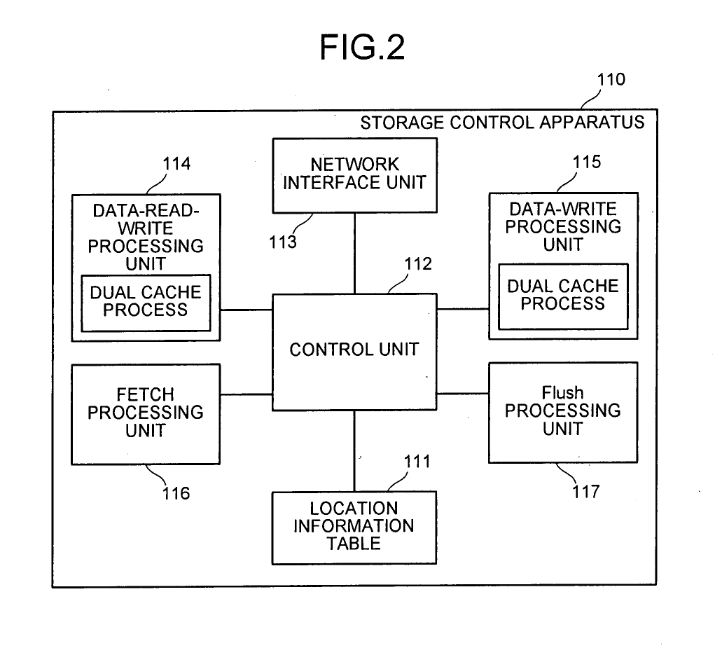

FIG. 2 is a block diagram for illustrating a functional configuration of the storage control apparatus 110 shown in FIG. 1. The storage control apparatus 110 includes a location information table 111, a control unit 112, a network interface unit 113, a data-read processing unit 114, a data-write processing unit 115, a Fetch processing unit 116, and a Flush processing unit 117.

The location information table 111 is a table in which a logical location designated by the client 10, a physical location in the disk 121 in which data is actually stored and a physical location in the cache memory, and a status of the data (whether the data is coherent or dirty) are stored in association with each other, with respect to data requested for an access by the client 10.

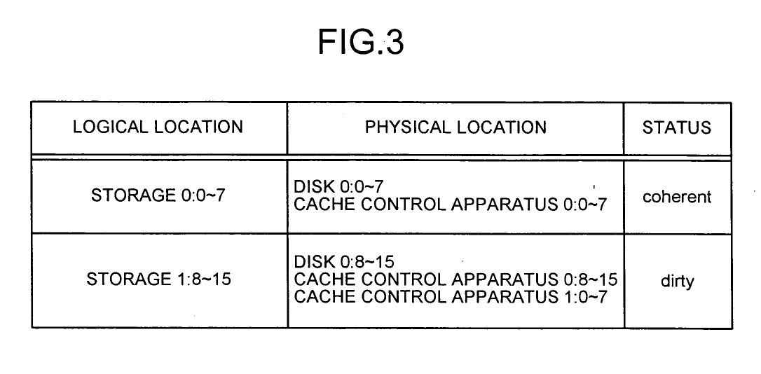

FIG. 3 is an example of the location information table 111. The data having a logical location of 0 to 7 in a device No. 0 is stored in 0 to 7 in the disk 121 having the device No. 0 and in the cache memory 0 to 7 in the cache control apparatus 130 having the device No. 0, and is in a status of coherent. The data having a logical location of 8 to 15 in a device No. 1 is stored in 8 to 15 in the disk 121 having the device No. 0 and in the cache memory 8 to 15 in the cache control apparatus 130 having the device No. 0 and the cache memory 0 to 7 in the cache control apparatus 140 having the device No. 1, and is in a status of dirty.

With this configuration in which the location information table 111 stores a physical location of data to be stored in the cache memories of the two cache control apparatuses 130 and 140 in association with each other, the storage control apparatus 110 can handle a process corresponding to the redundant cache control apparatus.

The control unit 112 is a processing unit that controls the whole storage control apparatus 110. The network interface unit 113 is a processing unit that performs a communication with the client 10, the real-disk control apparatus 120, and the cache control apparatuses 130 and 140, using a predetermined communication protocol.

The data-read processing unit 114 is a processing unit that performs a data-read from the storage system in response to a request for the data-read from the client 10. The data-read processing unit 114 acquires a physical location from a logical location of data using the location information table 111, and when the data is stored in the cache memory, instructs the cache control apparatus having the cache memory in which the data is stored to transfer the data to the client 10. On the other hand, when the data is not stored in the cache memory, the data-read processing unit 114 makes a request to the Fetch processing unit for transferring the data from the real-disk control apparatus 120 to the cache control apparatus. After the data is transferred from the real-disk control apparatus 120 to the cache control apparatus, the data-read processing unit 114 instructs the cache control apparatus to which the data is transferred to transfer the data to the client 10.

The data-write processing unit 115 is a processing unit that performs a data-write into the storage system in response to a request for the data-write from the client 10, and instructs both the cache control apparatuses 130 and 140 to write data into the cache memory based on the location information table 111. When a storage location of the data in the cache memory is registered in the location information table 111, the data-write processing unit 115 instructs to write the data into the storage location, and when a storage location of the data in the cache memory is not registered in the location information table 111, the data-write processing unit 115 instructs to allocate a new location in the cache memory, and to write the data into the new location allocated.

With this mechanism, because the data-write processing unit 115 controls to write the same data into both cache memories in response to a request for a data-write from the client 10, even when a failure has occurred in either of the cache control apparatuses, it is possible to prevent a shut down of the storage system, and to improve a reliability of the storage system.

The Fetch processing unit 116 is a processing unit that selects, when the data for which a request for a data-read is issued from the client 10 is not stored in the cache memory, a cache control apparatus for storing the data, and instructs the real-disk control apparatus 120 to transfer the data to the cache control apparatus selected.

The Flush processing unit 117 is a processing unit that writes data in a status of dirty from among the data stored in the cache memory into the disk 121, and is used for making a free area in the cache memory when the free area is not sufficient in the cache memory or a usage area of the cache memory exceeds a predetermined ratio at a time of writing data into the cache memory. When making the free area in the cache memory, a selection of data to be deleted from the cache memory is made by using a method like least recently used (LRU), and when the data determined to be deleted from the cache memory is in a status of dirty, the Flush processing unit 117 is used.

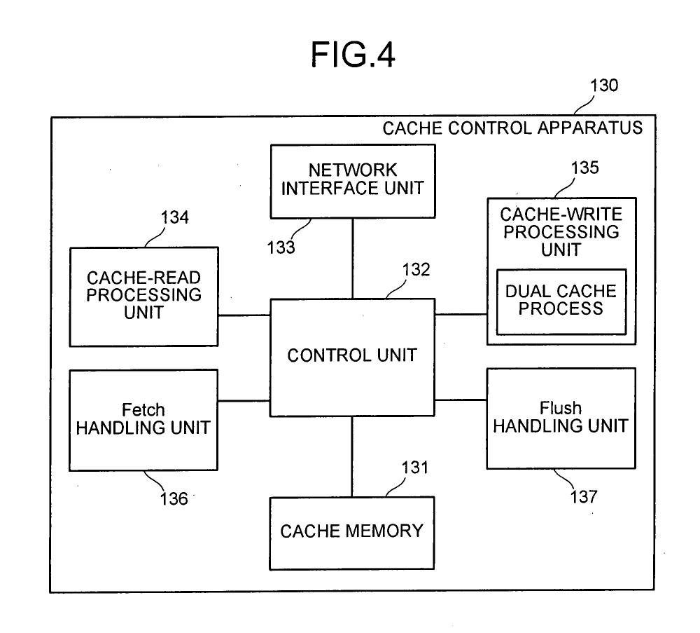

In an explanation for a configuration of the cache control apparatuses 130 and 140 shown in FIG. 1, the cache control apparatus 130 is explained as an example because the cache control apparatuses 130 and 140 have the same configuration. FIG. 4 is a block diagram for illustrating a functional configuration of the cache control apparatus 130 shown in FIG. 1. As shown in the figure, the cache control apparatus 130 includes a cache memory 131, a control unit 132, a network interface unit 133, a cache-read processing unit 134, a cache-write processing unit 135, a Fetch handling unit 136, and a Flush handling unit 147.

The cache memory 131 is a storing unit for a high-speed access to the storage system, storing a part of data stored in the disk 121 and data to be stored in the disk 121, and having a shorter access time and a small capacity compared to the disk 121. The data stored in the cache memory 131 and its storing location are stored in the location information table 111 of the storage control apparatus 110.

The control unit 132 is a processing unit that controls the entire cache control apparatus 130, and the network interface unit 133 is a processing unit that performs a communication with the client 10, the storage control apparatus 110, and the real-disk control apparatus 120 using a predetermined communication protocol.

The cache-read processing unit 134 is a processing unit that performs a data-read from the cache memory 131 based on an instruction for data-read from the storage control apparatus 110, and transfers the data-read to the client 10.

The cache-write processing unit 135 is a processing unit that reads data from a buffer of the client 10 based on an instruction for data-read from the storage control apparatus 110, and writes the data-read into the cache memory 131. When a data-write into the cache memory 131 is completed, the cache-write processing unit 135 notifies the client 10 of a completion of the data-write. The notification of the completion corresponds to a redundancy of the cache control apparatus, and its detail will be described later.

The Fetch handling unit 136 is a processing unit that writes data, which is to be transmitted to the cache control apparatus 130 by the real-disk control apparatus 120, into the cache memory 131, based on an instruction from the Fetch processing unit 116 of the storage control apparatus 110.

The Flush handling unit 137 is a processing unit that reads data from the cache memory 131, and transfers the data-read to the real-disk control apparatus 120, based on an instruction from the Flush processing unit 117 of the storage control apparatus 110.

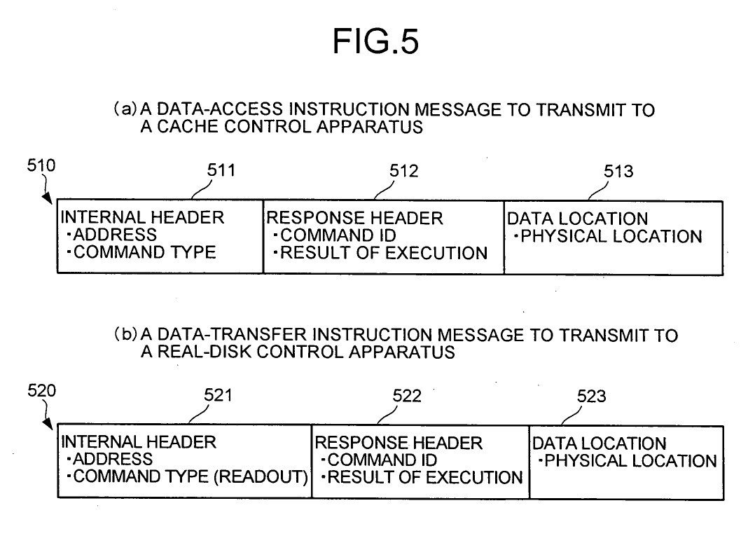

FIG. 5 is a schematic diagram for illustrating an example of a message transmitted from the storage control apparatus 110. FIG. 5 (A) indicates a message instructing a data access to the cache memory, transmitted to the cache control apparatuses 130 and 140 from the storage control apparatus 110; and FIG. 5 (B) indicates a message instructing a data transfer, transmitted to the real-disk control apparatus 120 from the storage control apparatus 110.

As shown in FIG. 5 (A), the message instructing a data access to the cache memory, which is transmitted to the cache control apparatuses 130 and 140 from the storage control apparatus 110, includes an internal header 511, a response header 512, and a data location 513.

The internal header 511 includes an address of the client 10 or the real-disk control apparatus 120 with which the cache control apparatuses 130 and 140 performs a data transaction, and a command type indicating whether the instruction is for a data-read from the cache memory (read-out) or for a data-write into the cache memory (write-in).

When the data-access instruction message 510 is for writing data into the cache memory, the address is an address of the client 10 that requested for the data-write, and the command type is the “write-in”. On the other hand, when the data-access instruction message 510 is for reading data from the cache memory, the address is an address of the client 10 that requested for the data-read, and the command type is the “read-out”. In addition, when the data-access instruction message 510 is for transferring data from the cache memory to the disk 121, the address is an address of the real-disk control apparatus 120 of a destination of transferring the data, and the command type is the “read-out”.

The response header 512 is a header format for reporting a result of executing the process instructed from the storage control apparatus 110 by the cache control apparatuses 130 and 140 to the client 10 or the storage control apparatus 110. The response header 512 includes a command ID for identifying a request from the client 10 and the like, and a result of execution indicating whether the execution is succeeded or failed. Data included in the response header 512 of the data-access instruction message 510 for instructing a data-write into the cache memory will be described later.

The data location 513 includes physical addresses of the disk 121 that stores data and the cache memory. When the data is not stored in the cache memory, only a physical address of the disk 121 is included.

Similarly, a data-transfer instruction message 520 that is transmitted from the storage control apparatus 110 to the real-disk control apparatus 120 includes an internal header 521, a response header 522, and a data location 523.

The internal header 521 includes an address of the cache control apparatus 130 or 140 that is a destination of transferring data, and a “read-out” as the command type. The response header 522 is a header format for reporting a result of the data transfer (success or fail) to the storage control apparatus 110 by the real-disk control apparatus 120. The data location 523 includes a physical location designating a data location in the disk 121 that stores data to be transmitted, and a storing location of data in the cache memory that is a destination of writing the data.

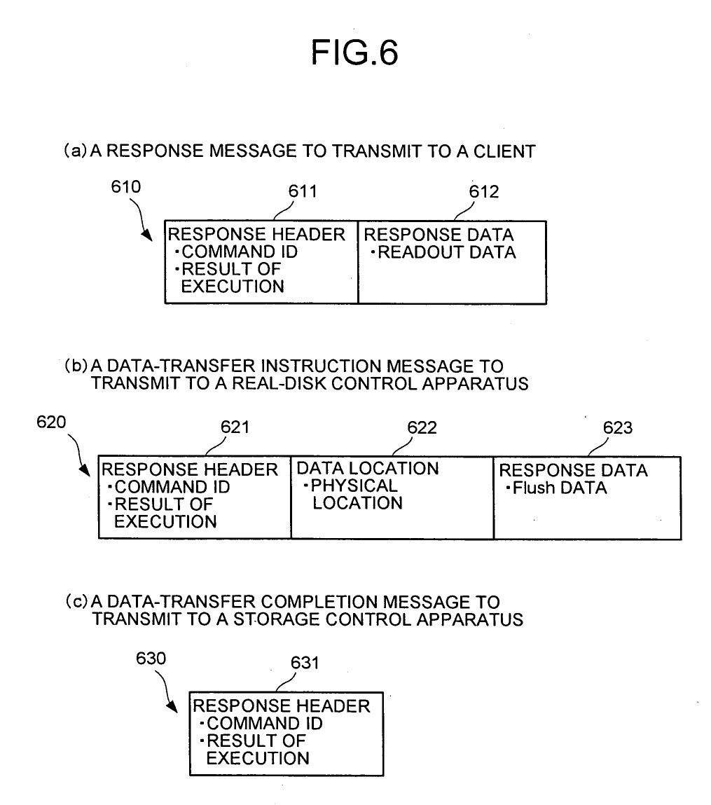

FIG. 6 is a schematic diagram for illustrating an example of a message transmitted from the cache control apparatuses 130 and 140. FIG. 6 (A) indicates a response message 610 to transmit to the client 10 a result of executing a data-read process from the cache memory or a data-write process into the cache memory based on a request from the client 10; FIG. 6 (B) indicates a data-transfer message 620 to transmit data from the cache memory to the real-disk control apparatus 120 based on a Flush process; and FIG. 6 (C) indicates a data-transfer completion message to transfer to the storage control apparatus 110 when a data transfer to the real-disk control apparatus 120 is completed.

As shown in FIG. 6 (A), response message 610 transmitted from the cache control apparatuses 130 and 140 to the client 10 includes a response header 611 and a response data 612. The response header 611 includes a command ID for identifying a request from the client 10, and a result of executing a process instructed. When the request from the client 10 is a data-read, data-read from the cache memory becomes the response data 612. On the other hand, when the request from the client 10 is a data-write, there is no response data 612.

As shown in FIG. 6 (B), the data-transfer message 620 transmitted from the cache control apparatuses 130 and 140 to the real-disk control apparatus 120 includes a response header 621, a data location 622, and a response data 623. The response header 621 includes a command ID for identifying that the data-transfer message 620 is a data transfer based on a Flush process; the data location 622 includes a physical location designating a write location in the disk 121 for data to be transmitted; and the response data 623 is a Flush data that is read from the cache memory, and stored in the disk 121.

As shown in FIG. 6 (C), the data-transfer completion message 630 transmitted from the cache control apparatuses 130 and 140 to the storage control apparatus 110 includes a response header 631. The response header 631 includes a command ID that is included in an instruction message from the storage control apparatus 110 corresponding to the response and a result of executing a process instructed.

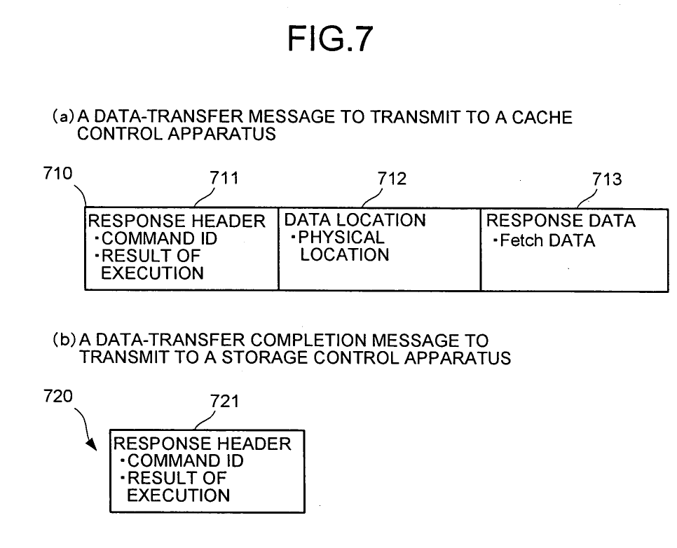

FIG. 7 is a schematic diagram for illustrating an example of a message transmitted from the real-disk control apparatus 120. FIG. 7 (A) indicates a data-transfer message 710 to transmit data stored in the disk 121 from the real-disk control apparatus 120 to the cache control apparatuses 130 and 140 based on a Fetch process; and FIG. 7 (B) indicates a data-transfer completion message 720 transmitted from the real-disk control apparatus 120 to the storage control apparatus 110 when a data transfer to the cache control apparatus 130 or 140 is completed.

As shown in FIG. 7 (A), the data-transfer message 710 transmitted from the real-disk control apparatus 120 to the cache control apparatuses 130 and 140 includes a response header 711, a data location 712, and a response data 713. The response header 711 includes a command ID for identifying that the data-transfer message 710 is a data transfer based on a Fetch process; the data location 712 includes a physical location designating a write location of data to be transmitted in the cache memory; and the response data 713 is Fetch data that is read from the disk 121, and is to be written into the cache memory.

As shown in FIG. 7 (B), the data-transfer completion message 720 transmitted to the storage control apparatus 110 includes a response header 721. The response header 721 includes a command ID that is included in an instruction message from the storage control apparatus 110 corresponding to the response and a result of executing a process instructed.

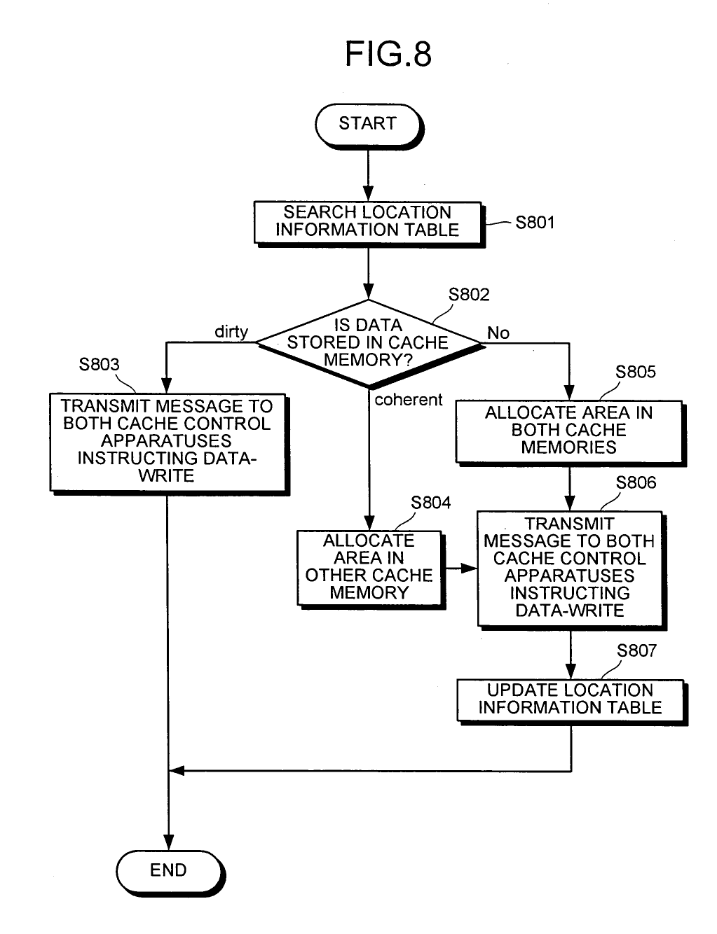

FIG. 8 is a flowchart of a process procedure for the data-write processing unit 115 of the storage control apparatus 110.

The data-write processing unit 115 searches the location information table 111 using a logical location of data for writing designated by the client 10 (Step S801), and checks if the data is stored in the cache memory in a status of dirty, the data is stored in the cache memory in a status of coherent, or the data is not stored in the cache memory (Step S802).

When the data is stored in both cache memories, and the data is in a status of dirty, the data-write processing unit 115 issues an instruction to write data designated by the client 10 into the cache memory by transmitting the data-access instruction message 510 to both the cache control apparatuses 130 and 140 with the command type set to “write-in” (Step S803).

When the data is stored in either of the two cache memories, and the data is in a status of coherent, the data-write processing unit 115 secures an area for storing the data in a cache memory in which the data is not stored, and transmits the data-access instruction message 510 to both the cache control apparatuses 130 and 140 with the command type set to “write-in” (Step S806). Then, the data-write processing unit 115 updates the location information table 111 for the newly secured area in the cache memory (Step S807).

On the other hand, when the data is not stored any of the cache memories, the data-write processing unit 115 secures an area for storing the data in both the cache memories (Step S805), and transmits the data-access instruction message 510 to both the cache control apparatuses 130 and 140 with the command type set to “write-in” (Step S806). Then, the data-write processing unit 115 updates the location information table 111 for the newly secured area in the cache memory (Step S807).

In this manner, because the data-write processing unit 115 constantly writes data requested by the client 10 into both the cache memories, even when a failure has occurred in one of the cache control apparatuses, it is possible to prevent a loss of data.

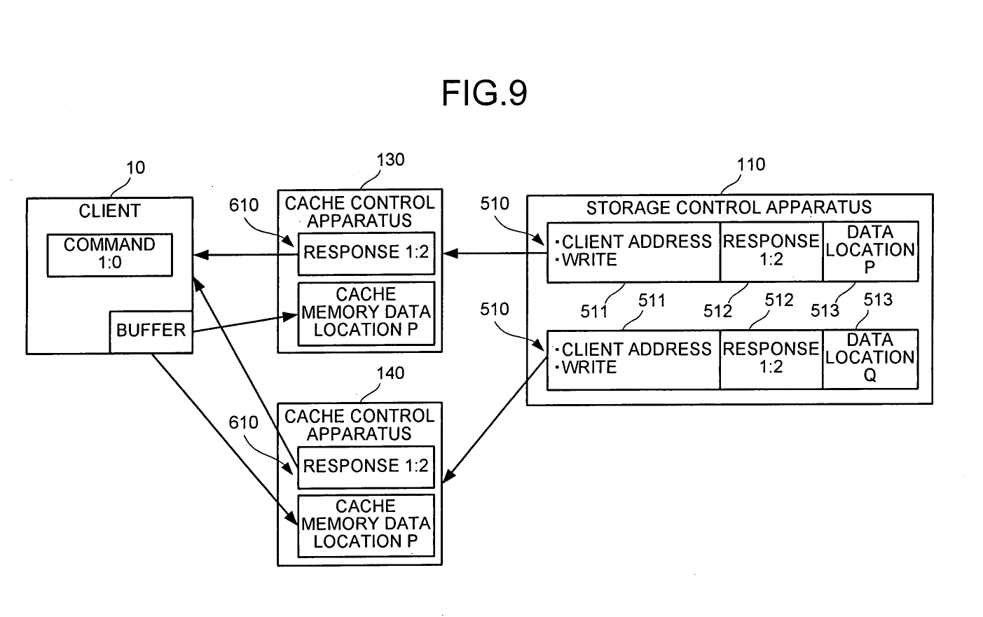

The storage system employs two cache control apparatuses 130 and 140, and it is necessary to write data into the cache memories of the two cache control apparatuses 130 and 140. Therefore, a completion of data-write is a time when the data-write into both the cache control apparatuses 130 and 140 is completed. FIG. 9 is a schematic diagram for explaining a method of determining a completion of a data-write into the storage system by the client 10.

As shown in the figure, upon receiving a request (command ID is “command 1”) from the client 10 for a data-write, the storage control apparatus 110 transmits the data-access instruction message 510 to both the cache control apparatuses 130 and 140. The data-access instruction message 510 includes the internal header 511 having an address of the client 10 that is a source of the request for the data-write with a command type of “write-in”, the response header 512 having data designating that the number of responses to the “command 1” is two (response 1:2), and the data location 513 having a data location P and a data location Q as locations of writing data in the cache memory.

Upon receiving the data-access instruction message 510, the cache control apparatuses 130 and 140 reads data from a buffer of the client 10. The cache control apparatus 130 writes the data-read into the data location P in the cache memory, and the cache control apparatus 140 writes the data-read into the data location Q in the cache memory. When the data-write is completed, the cache control apparatuses 130 and 140 transmits a response message 610 created based on the response header 512 to the client 10. The response message 610 includes the data designating that the number of responses to the “command 1” is two (response 1:2).

The client 10 receives the response message 610 from the cache control apparatus 130 or 140, checks that the number of the responses to the “command 1” is two, and waits for the response message 610 from the other cache control apparatus. Upon receiving the response message 610 from the other cache control apparatus, the client 10 determines that the data-write into the storage system is completed.

In this manner, because the storage control apparatus 110 designates that the number of the response messages 610 is two using the response header 512, and the client 10 determines that the data-write into the storage system is completed at a time when two of the response messages 610 are received by counting the number of the response messages 610 from the cache control apparatus, it is possible to ensure that the same data is written into the cache memories of the two cache control apparatuses 130 and 140.

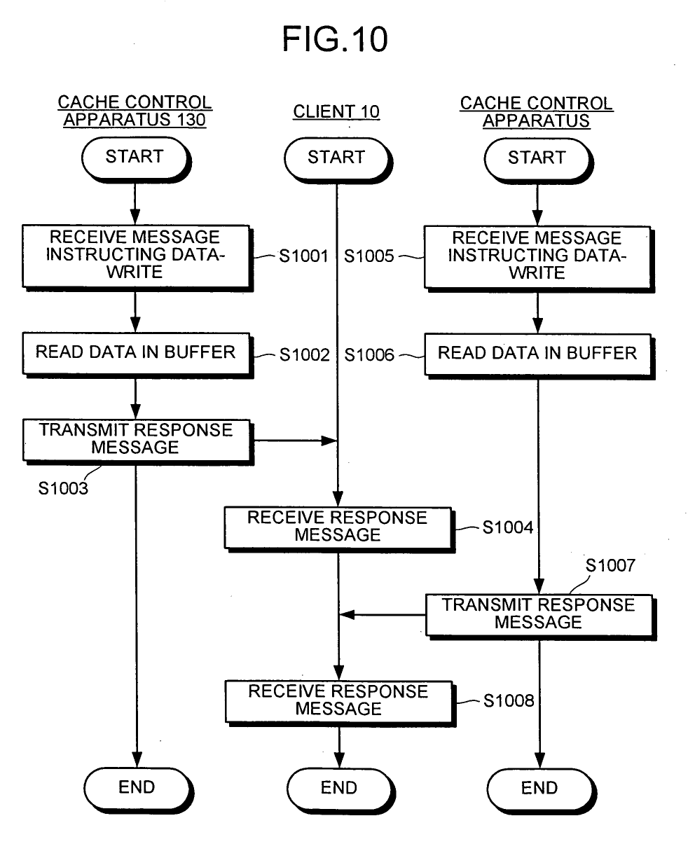

FIG. 10 is a flowchart of a process procedure for a data-write process into the cache memory according to the first embodiment. In this example, the cache control apparatus 130 completes a data-write into the cache memory earlier than the cache control apparatus 140.

Upon receiving a data-access instruction message 510 from the storage control apparatus 110 (Step S1001), the cache control apparatus 130 reads data from a buffer of the client 10 (Step S1002), and writes the data read into the cache memory. A location of writing the data in the cache memory is designated by the data location 513 that belongs to the data-access instruction message 510. When the data-write into the cache memory is completed, the cache control apparatus 130 transmits the response message 610 to the client 10 (Step S1003).

Similarly, the other cache control apparatus 140 receives the data-access instruction message 510 from the storage control apparatus 110 (Step S1005), reads data from a buffer of the client 10 (Step S1006), and writes the data read into the cache memory. When the data-write into the cache memory is completed, the cache control apparatus 140 transmits the response message 610 to the client 10 (Step S1007).

The client 10 firstly receives the response message 610 from the cache control apparatus 130 (Step S1004), recognizes that it is necessary to receive two response messages 610 by interpreting the response header 611, and waits for the next response message 610. When the response message 610 is received from the cache control apparatus 140 (Step S1008), the client determines that the data-write into both the cache control apparatuses 130 and 140 is completed.

Although, in this example, when the cache control apparatuses 130 and 140 complete the data-write into the cache memory, the client 10 transmits the response message 610, the cache control apparatuses 130 and 140 can also notify, when the data-write into the cache memory is completed, a completion of the data-write to the storage control apparatus 110 instead of the client 10. In this case, because the storage control apparatus 110 instructs the two cache control apparatuses 130 and 140 to write data, it is possible to notify the client 10 of a completion of the data-write after receiving a notification of the completion of the data-write from the cache control apparatuses 130 and 140 to which the instruction was issued.

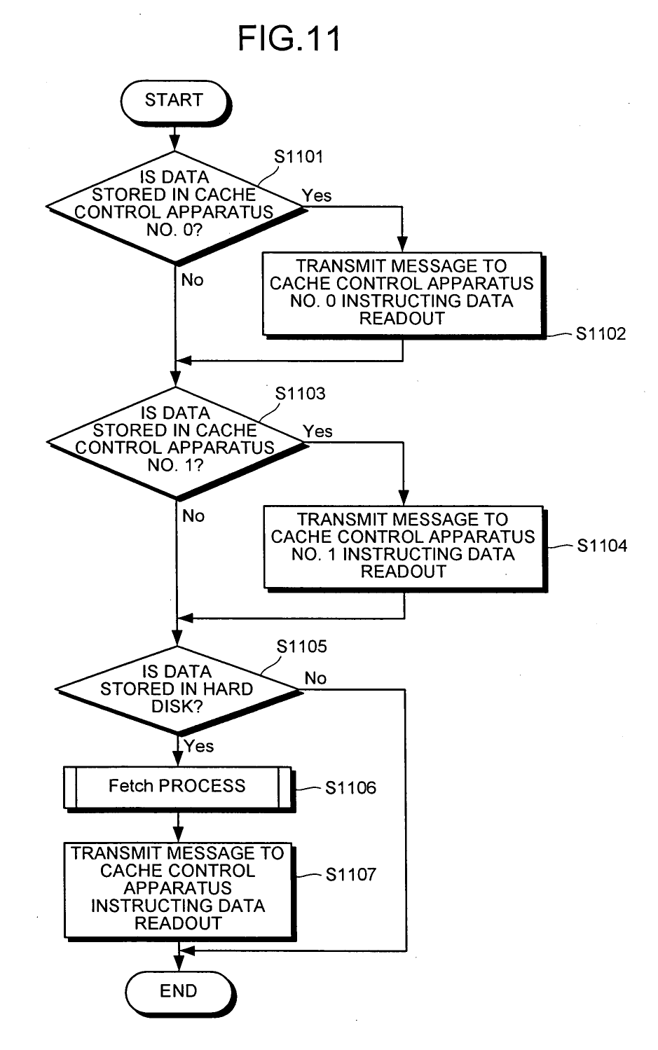

FIG. 11 is a flowchart of a process procedure for the data-read processing unit 114 of the storage control apparatus 110 shown in FIG. 2. As shown in the figure, the data-read processing unit 114 checks if data requested to be read from the client 10 is stored in the cache control apparatus 130 No. 0, using the location information table 111 (Step S1101). When the data is stored in the cache control apparatus 130 No. 0, the data-read processing unit 114 transmits the data-access instruction message 510 to the cache control apparatus 130 No. 0, with command type set to “read-out” (Step S1102), and instructs to transmit the data stored in the cache memory to the client 10.

On the other hand, when the data requested to be read from the client 10 is not stored in the cache control apparatus 130 No. 0, the data-read processing unit 114 checks if the data is stored in the cache control apparatus 140 No. 1 (Step S1103). In addition, when all the data requested to be read from the client 10 is not stored in the cache control apparatus 130 No. 0, the data-read processing unit 114 checks if the rest of the data is stored in the cache control apparatus 140 No. 1 (Step S1103). When the desired data is stored in the cache control apparatus 140 No. 1, the data-read processing unit 114 transmits the data-access instruction message 510 to the cache control apparatus 140 No. 1, with command type set to “read-out” (Step S1104), and instructs to transmit the data stored in the cache memory to the client 10.

When the data requested to be read from the client 10 is not stored in the cache control apparatus 140 No. 1, the data-read processing unit 114 checks if the data is stored in the disk 121 (Step S1105). Also, when all the data requested to be read from the client 10 is not stored in the cache control apparatus 130 No. 0, the data-read processing unit 114 checks if the rest of the data is stored in the disk 121 (Step S1105). When the desired data is stored in the disk 121, the data-read processing unit 114 reads the data using a Fetch process, and writes the data read into the cache memory (Step S1106). Then, the data-read processing unit 114 transmits the data-access instruction message 510 to the cache control apparatus having the cache memory into which the data is written, with command type set to “read-out” (Step S1107), and instructs to transmit the data stored in the cache memory to the client 10.

In this manner, the data-read processing unit 114 searches a storing location of data requested to be read from the client 10 using the location information table 111, and when the data is stored in either of the two cache control apparatuses 130 and 140, instructs to transmit the data to the client 10, thereby performing a data-read corresponding to a redundancy of the cache memory.

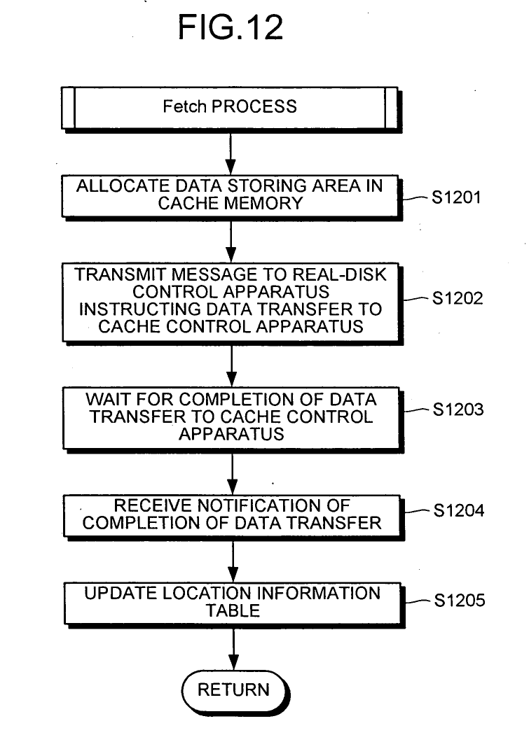

FIG. 12 is a flowchart of a process procedure for the Fetch processing unit 116 of the storage control apparatus 110 shown in FIG. 2. As shown in the figure, the Fetch processing unit 116 secures an area for storing data in the cache memory, using the location information table 111 (Step S1201), and instructs the real-disk control apparatus 120 to transmit data to the cache control apparatus having the area secured in the cache memory (Step S1202). Then, the Fetch processing unit 116 waits for the real-disk control apparatus 120 to complete transmitting the data to the cache control apparatus (Step S1203), and when the data-transfer completion message 720 is received from the real-disk control apparatus 120 (Step S1204), updates the location information table 111 for the newly secured cache memory area (Step S1205).

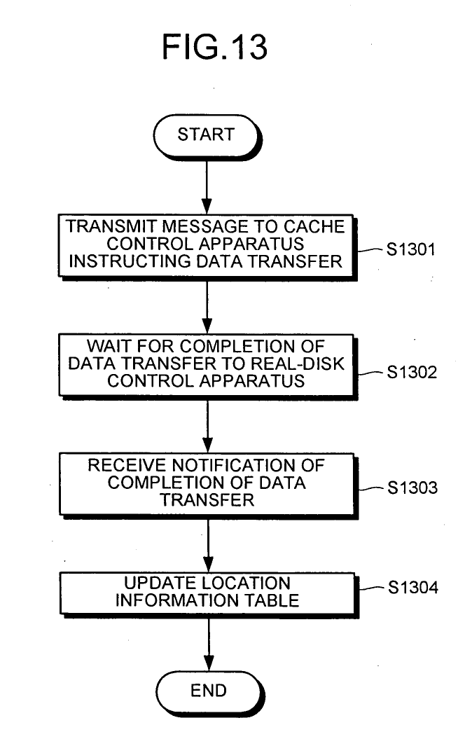

FIG. 13 is a flowchart of a process procedure for the Flush processing unit 117 of the storage control apparatus 110 shown in FIG. 2. As shown in the figure, the Flush processing unit 117 transmits a message to the cache control apparatus in which the data to be transferred to the disk 121 is stored, instructing a data transfer to the real-disk control apparatus 120. In other words, the Flush processing unit 117 takes an address of the internal header 511 as an address of the real-disk control apparatus 120, and instructs to transfer data to the real-disk control apparatus 120 (Step S1301).

Then, the Flush processing unit 117 waits for the cache control apparatus to complete transferring the data to the real-disk control apparatus 120 (Step S1302), and when the data-transfer completion message 630 is received from the cache control apparatus (Step S1303), frees the cache memory area in which the data transmitted has been stored, and updates the location information table 111 for the cache memory area freed (Step S1304).

As described above, according to the first embodiment, two of the cache control apparatuses 130 and 140 are arranged in the storage system, and the same data is stored in both the cache control apparatuses 130 and 140. Therefore, even when a failure has occurred in on of the cache control apparatuses, it is possible to operate the storage system using the other cache control apparatus, and to build a storage system with a high reliability.

Furthermore, when the data stored in the disk 121 is identical to the data stored in the cache control apparatuses 130 and 140 (coherent), a cache memory of either of the cache control apparatuses is freed, and only when the data stored in the disk 121 is different from the data stored in the cache control apparatus, the same data is stored in both the cache control apparatuses 130 and 140. Therefore, it is possible to use the cache memory efficiently, and to improve the cache hit ratio.

According to the first embodiment, a reliability of a storage system is improved by making a cache control apparatus redundant. However, a redundant cache control apparatus plus a redundant storage system can even more improve the reliability of the storage system. According to a second embodiment of the present invention, a storage system in which the storage control apparatus is made redundant as well as the cache control apparatus is explained.

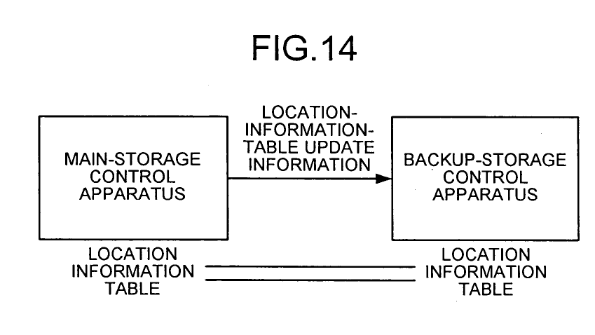

FIG. 14 is a schematic diagram for illustrating a concept of the redundancy in the storage control apparatus according to the second embodiment. As shown in the figure, the storage system includes two storage control apparatuses: a main-storage control apparatus and a backup-storage control apparatus.

In a normal operation of the storage system, the main-storage control apparatus from among the two storage control apparatuses is working as a storage control apparatus of the storage system. Both the main-storage control apparatus and the backup-storage control apparatus include a location information table, and each time the main-storage control apparatus updates the location information table, the main-storage control apparatus transmits a content of the update to the backup-storage control apparatus. The backup-storage control apparatus receives the content of the update, and updates its location information table to maintain the location information table in a latest status constantly.

With this mechanism, the storage system according to the second embodiment constantly maintains the location information table of the main-storage control apparatus and the location information table of the backup-storage control apparatus in the same status. Therefore, even when a failure has occurred in the main-storage control apparatus, it is possible to operate the storage system using the backup-storage control apparatus, and to realize a highly reliable storage system.

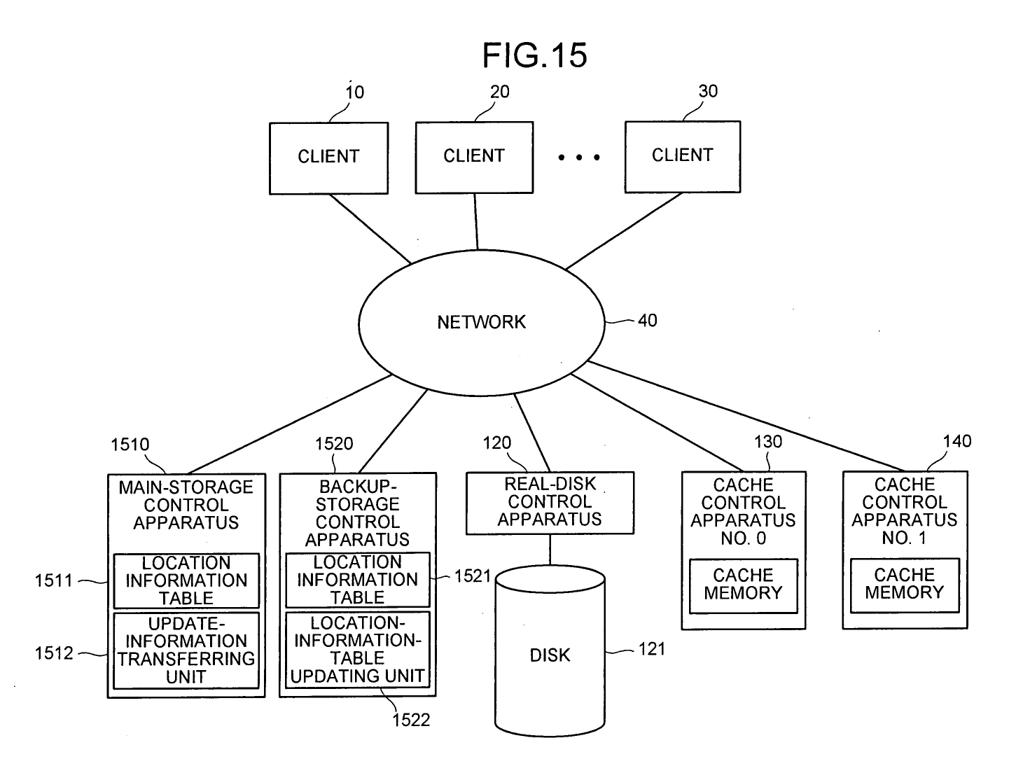

FIG. 15 a schematic diagram for illustrating a system configuration of a storage system according to the second embodiment. In this example, for the sake of convenience, function units taking the same roles as those shown in FIG. 1 have the same reference numerals, and a detailed explanation for those units are omitted.

As shown in the figure, in this storage system, a main-storage control apparatus 1510, a backup-storage control apparatus 1520, a real-disk control apparatus 120, and two cache control apparatuses 130 and 140 are distributed on a network 40.

The main-storage control apparatus 1510, in a normal operation of the storage system, receives an access request from a client 10 via the network 40, and causes the real-disk control apparatus 120, and the cache control apparatuses 130 and 140 to execute a process corresponding to the access request. The main-storage control apparatus 1510 includes a location information table 1511 and an update-information transmitting unit 1512.

The location information table 1511 is a table in which a logical location designated by the client 10, a physical location of in the disk 121 in which data is actually stored and a physical location in the cache memory, and a status of the data whether the data is coherent or dirty are stored in association with each other, with respect to data requested for an access by the client 10.

The update-information transmitting unit 1512 is a processing unit that transmits a content of an update to the backup-storage control apparatus 1520 each time the location information table 1511 is updated. The update of the location information table 1511 is performed when data stored in the cache memory becomes unnecessary by a Flush process, when a new cache memory is allocated by a Fetch process, and when a new cache memory is allocated in a data-write process.

The backup-storage control apparatus 1520 takes over a process when a failure has occurred in the main-storage control apparatus 1510. The backup-storage control apparatus 1520 includes a location information table 1521 and a location-information-table updating unit 1522.

The location information table 1521 is a table in which the same data as that in the location information table 1511 of the main-storage control apparatus 1510 is stored. Because the location information table 1521 stores the same data as that in the location information table 1511, when a failure has occurred in the main-storage control apparatus 1510, the backup-storage control apparatus 1520 can take over a process.

The location-information-table updating unit 1522 is a processing unit that receives update information of the location information table 1511 transmitted from the update-information transmitting unit 1512 of the main-storage control apparatus 1510, and updates the location information table 1521 of the backup-storage control apparatus 1520. With this mechanism of updating the location information table 1521 by the location-information-table updating unit 1522, it is possible to maintain the location information table 1521 in a latest status constantly, and when a failure has occurred in the main-storage control apparatus 1510, the backup-storage control apparatus 1520 can take over a process.

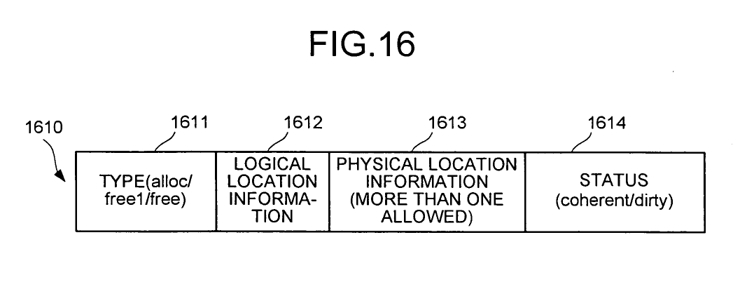

FIG. 16 is a schematic diagram for illustrating an example of a location-information update message. As shown in the figure, a location-information update message 1610 includes a type 1611, a logical location information 1612, a physical location information 1613, and a status 1614.

The type 1611 indicates a type of update of the location information table, and includes a new allocation of the cache memory (alloc), a free of a part of the redundant cache memory (free1), and a free of the whole cache memory (free).

The logical location information 1612, the physical location information 1613, and the status 1614 are pieces of information corresponding to a logical location, a physical location, and a status in the location information table, respectively. In other words, the logical location information 1612 is information on a logical location that is a storing location of data used for an access to the storage system by the client 10; the physical location information 1613 is information on physical locations including a storing location of data in the disk 121 for storing the data and the cache memory; and the status 1614 is information indicating whether data stored in the disk 121 is identical to data stored in the cache memory.

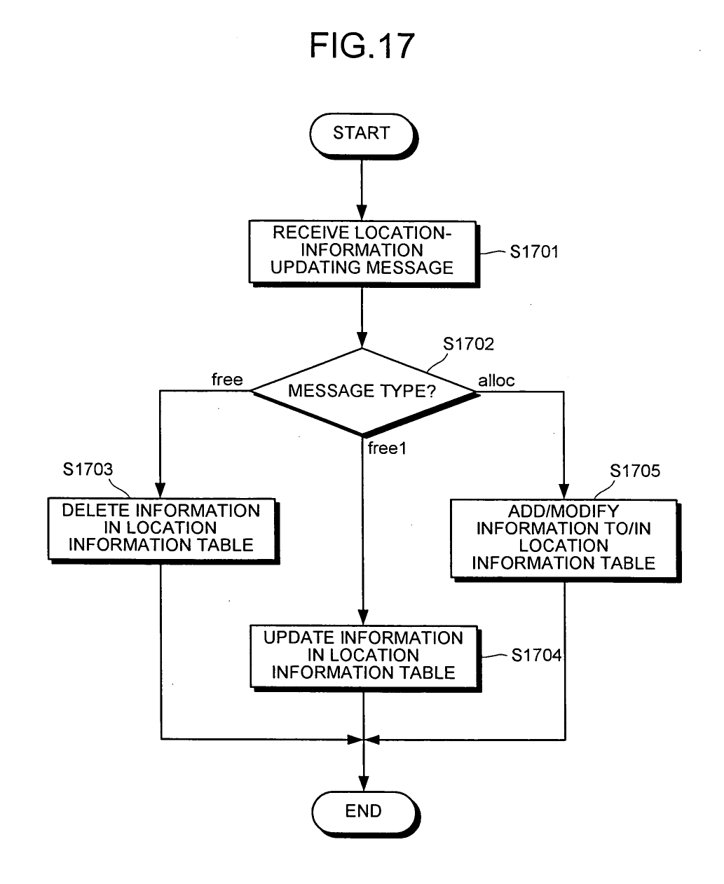

FIG. 17 is a flowchart of a process procedure for the location-information-table updating unit 1522 of the backup-storage control apparatus 1520 shown in FIG. 15. As shown in the figure, the location-information-table updating unit 1522 receives the location-information update message 1610 transmitted from the update-information transmitting unit 1512 of the main-storage control apparatus 1510 to the backup-storage control apparatus 1520, via the network 40 (Step S1701).

Then, the location-information-table updating unit 1522 searches the type 1611 of the location-information update message 1610 (Step S1702), when the type 1611 is “free”, deletes information corresponding to freed cache memory area from the location information table 1521 (Step S1703), and when the type 1611 is “free1”, updates information in the location information table 1521 corresponding to partly freed cache memory area (Step S1704). When the type 1611 of the location-information update message 1610 is “alloc”, if information corresponding to newly allocated cache memory area is in the location information table 1521, the location-information-table updating unit 1522 updates the information, and if the information corresponding to newly allocated cache memory area is not in the location information table 1521, creates new corresponding information to add the information created to the location information table 1521 (Step S1705).

As described above, according to the second embodiment, the storage system is made redundant using the main-storage control apparatus 1510 and the backup-storage control apparatus 1520. Both of the storage control apparatuses 1510 and 1520 include the location information table 1511 and 1521, respectively. Each time the location information table 1511 is updated, the update-information transmitting unit 1512 of the main-storage control apparatus 1510 transmits the location-information update message 1610 to the backup-storage control apparatus 1520; and the location-information-table updating unit 1522 of the backup-storage control apparatus 1520 immediately updates the location information table 1521. Therefore, even when a failure has occurred in the main-storage control apparatus 1510, the backup-storage control apparatus 1520 can take over a process to operate the storage system. As a result, it is possible to realize a highly reliable storage system.

According to the second embodiment, the update-information transmitting unit 1512 of the main-storage control apparatus 1510 transmits the location-information update message 1610 to the backup-storage control apparatus 1520, and the backup-storage control apparatus 152 immediately updates the location information table 1521 using the location-information update message 1610. However, the backup-storage control apparatus 1520 can keep the location-information update message 1610 as a log, and update the location information table 1521 at a time when a failure has occurred so that the backup-storage control apparatus 1520 has taken over a process, instead of updating the location information table 1521 immediately.

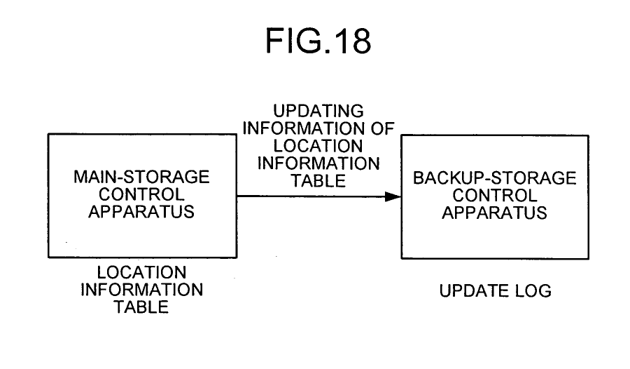

FIG. 18 is a schematic diagram for explaining a concept of a modification of the redundancy in the storage control apparatus according to the second embodiment. As shown in the figure, in an example of the modification of the redundancy in the storage control apparatus, the main-storage control apparatus transmits update information to the backup-storage control apparatus each time the location information table is updated. The backup-storage control apparatus that received the update information, instead of updating the location information table immediately, keeps the update information as a log. When a failure has occurred in the main-storage control apparatus so that the backup-storage control apparatus has taken over a process, the backup-storage control apparatus updates the location information table using the update log kept.

As described above, according to the modification of the second embodiment, the backup-storage control apparatus keeps the update information as a log instead of updating the location information table immediately. Therefore, it is possible to reduce a process load of the backup-storage control apparatus, and to use the backup-storage control apparatus for other process effectively.

Third Embodiment

According to the first and the second embodiments, a case in which two cache control apparatuses are used explained. However, it is necessary to increase the number of the cache control apparatuses sequentially to prevent a drop down of cache hit ratio accompanied by an increase of the disk 121. According to a third embodiment of the present invention, a storage system using n number of cache control apparatuses is explained.

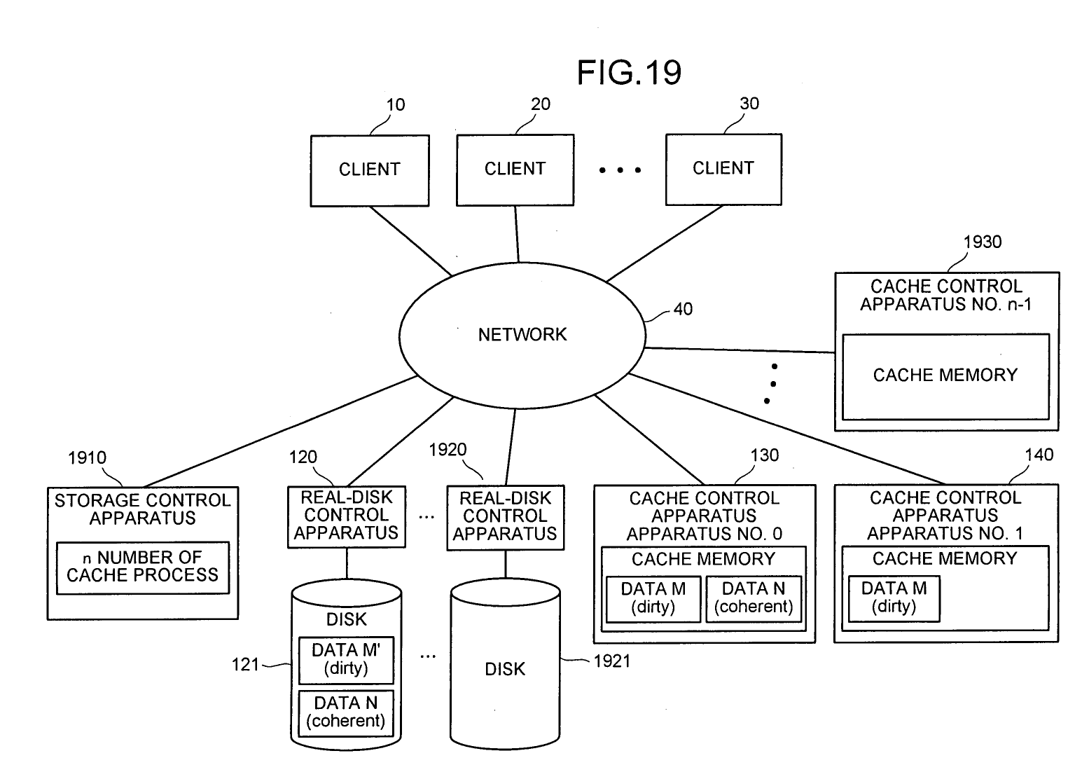

FIG. 19 is a schematic diagram for illustrating a system configuration of a storage system according to the third embodiment. In this example, for the sake of convenience, function units taking the same roles as those shown in FIG. 1 have the same reference numerals, and a detailed explanation for those units are omitted.

As shown in the figure, in this storage system, a storage control apparatus 1910, real-disk control apparatuses 120 and 1920, and cache control apparatuses 130, 140, and 1930 are distributed on a network 40. In this figure, for the sake of convenience, two real-disk control apparatuses 120 and 1920 and three cache control apparatuses 130, 140, and 1930 are shown. However, the storage system includes m number of real-disk control apparatuses and n number of cache control apparatuses.

The storage control apparatus 1910 controls the cache control apparatus in such a manner that two cache control apparatuses from among the n number of cache control apparatuses stores data in a status of dirty. In other words, the storage control apparatus 1910 controls the cache control apparatus so that, even when a failure has occurred in one of the n number of cache control apparatuses, data stored in the cache control apparatus having a failure exists in other cache control apparatus or in a disk, to realize a efficient usage of the cache memory and a highly reliable storage system.

The real-disk control apparatus 1920 and the cache control apparatus 1930 are newly added to the storage system to handle even larger-capacity data. However, it is not necessary for the cache control apparatus 1930 to store, for example, the data M in a status of dirty shown in FIG. 19. The reason is that it is not necessary for a third cache control apparatus to store the same data, because the two cache control apparatuses 130 and 140 stores the data M.

As described above, according to the third embodiment, n number of cache control apparatuses are arranged in the storage system, and for data in a status of dirty, which is not stored in a disk, the same data is stored in two cache control apparatuses from among the n number of cache control apparatuses. Therefore, it is possible to us the cache memory efficiently, and even when a failure has occurred in one of the n number of cache control apparatuses, to operate the storage system using the other cache control apparatuses. As a result, a highly reliable storage system can be realized.

Furthermore, according to the third embodiment, although two cache control apparatuses from among the n number of cache control apparatuses store the same data, the present invention is not limited to this scheme. To achieve a storage system with an even higher reliability, the present invention can be applied to a storage system in which more than three cache control apparatuses from among the n number of cache control apparatuses store the same data. Therefore, the number of cache control apparatuses that store the same data can be determined based on an operation environment of the system, a hit ratio of the cache memory, an access performance to data, and a requirement on a system reliability.

The present invention can also be applied to an even more flexible storage system by changing the number of cache control apparatuses that store the same data as needed according to a change in an operation environment of the storage system.

According to the third embodiment, although the same data is stored in arbitrary two cache control apparatuses, the present invention is not limited to this scheme. It is also possible to determine the cache control apparatus that stores the same data with respect to each of the cache control apparatuses, and to apply it, in the same manner, to a storage system that performs a backup for each of the cache control apparatuses.

According to the first, the second, and the third embodiments, although the explanation was for the storage control apparatus and the cache control apparatus, it is also possible to obtain a storage control program and a cache control program having a similar function, by implementing the configuration of the apparatuses with software.

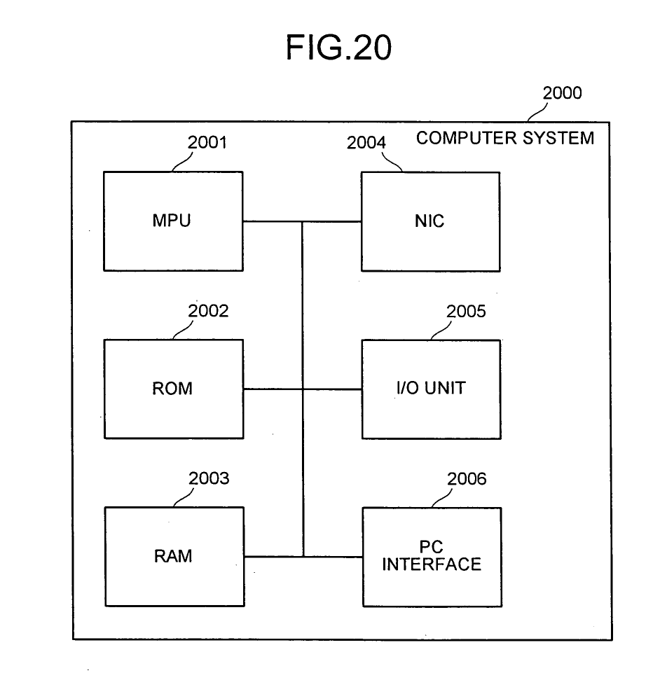

FIG. 20 is a schematic diagram for illustrating a computer system 2000 for executing a storage control program and a cache control program. As shown in the figure, the computer system 2000 includes a micro processing unit (MPU) 2001, a read only memory (ROM) 2002, a random access memory (RAM) 2003, a network interface card (NIC) 2004, a input/output unit 2005, and a PC interface 2006.

The MPU 2001 is a processing unit that executes a program, and in this case, executes the storage control program and the cache control program stored in the ROM 2002.

The ROM 2002 is a memory that stores a read-only program and data, and stores the storage control program and the cache control program prior to an execution of a program.

The RAM 2003 is a memory in which data read and write is possible, and stores, for example, temporary data created with an execution of a program by the MPU 2001. The location information table is stored in the RAM 2003.

The NIC 2004 is a device that performs a communication with, for example, a client, using a predetermined communication protocol, and executes a process of the network interface unit 113 shown in FIG. 2 and the network interface unit 133 shown in FIG. 4.

The input/output unit 2005 is a device like a keyboard, a mouse, and a display. The keyboard and the mouse are used for an instruction to the computer system 2000 and an input of data; and the display is used for displaying an execution status of the computer.

The PC interface 2006 is an interface with a personal computer used for, for example, a program development, and is used for loading a program developed on the personal computer, and exchanging debug information with the personal computer.

As described above, according to the present invention, a control is performed in such a manner that data, for which the client requested to write, is written into a predetermined number of cache devices from among the cache devices disposed on the network in a redundant manner, and when data, for which the client requested to read, is not stored in any cache device from among the cache devices disposed on the network, the data is read from a disk device, to store the data-read in a specific cache device, and to transmit the data-read to the client. Therefore, it is possible to use a cache memory with efficiency, to prevent a shut down of the entire storage system resulted from a failure of an individual device, and to build a storage system with a high reliability.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A storage control apparatus that is distributed on a network with a cache device and a disk device to constitute a storage system, receives an access request from a client, and causes the cache device and the disk device to execute a process corresponding to the access request, the storage control apparatus comprising:
a write control unit that performs a control to write data, for which the client requested to write, into a predetermined number of cache devices from among the cache devices disposed on the network in a redundant manner; and
a read control unit that performs, when data, for which the client requested to read, is not stored in any cache device from among the cache devices disposed on the network, controls to read the data from the disk device, to store the data-read in a specific cache device, and to transmit the data-read to the client.

2. The storage control apparatus according to claim 1, further comprising a Flush control unit that performs, when the data written into the predetermined number of cache devices in the redundant manner is written into the disk, controls to cause a specific cache device from among the predetermined number of cache devices to maintain the data, and to cause other cache devices to free a memory area for the data.

3. The storage control apparatus according to claim 1, wherein the write control unit performs the control to write the data, for which the client requested to write, into two cache devices from among the cache devices disposed on the network in the redundant manner.

4. The storage control apparatus according to claim 1, wherein the write control unit performs the control to write the data, for which the client requested to write, into all the cache devices disposed on the network in the redundant manner.

5. The storage control apparatus according to claim 1, wherein the write control unit instructs the predetermined number of cache devices to transmit the predetermined number with a notification of completion of writing the data to the client.

6. The storage control apparatus according to claim 1, further comprising:
a location-information storing unit that stores correspondence between a logical location designated by the client, a memory location in a cache device, and a storing location in a disk device for an area to store data for which the client makes a request for an access; and
an update-information transferring unit that transmits, every time an update is performed for the correspondence stored in the location-information storing unit, information on the update to other storage control apparatus disposed on the network.

7. A storage control method used for a storage control apparatus that is distributed on a network with a cache device and a disk device to constitute a storage system, to receive an access request from a client, and to cause the cache device and the disk device to execute a process corresponding to the access request, the storage control method comprising:
a writing control including performing a control to write data, for which the client requested to write, into a predetermined number of cache devices from among the cache devices disposed on the network in a redundant manner; and
a reading control including performing, when data, for which the client requested to read, is not stored in any cache device from among the cache devices disposed on the network, controls to read the data from the disk device, to store the data-read in a specific cache device, and to transmit the data-read to the client.

8. The storage control method according to claim 7, further comprising a cache control including performing, when the data written into the predetermined number of cache devices in the redundant manner is written into the disk, controls to cause a specific cache device from among the predetermined number of cache devices to maintain the data, and to cause other cache devices to free a memory area for the data.

9. The storage control method according to claim 7, wherein the writing control includes performing the control to write the data, for which the client requested to write, into two cache devices from among the cache devices disposed on the network in the redundant manner.

10. The storage control method according to claim 7, wherein the writing control includes performing the control to write the data, for which the client requested to write, into all the cache devices disposed on the network in the redundant manner.

11. The storage control method according to claim 7, wherein the writing control includes instructing the predetermined number of cache devices to transmit the predetermined number with a notification of completion of writing the data to the client.

12. The storage control method according to claim 7, further comprising:
storing correspondence between a logical location designated by the client, a memory location in a cache device, and a storing location in a disk device for an area to store data for which the client makes a request for an access; and
transferring, every time an update is performed for the correspondence stored at the storing, information on the update to other storage control apparatus disposed on the network.

13. A computer-readable recording medium that stores a storage control program used for a storage control apparatus that is distributed on a network with a cache device and a disk device to constitute a storage system, to receive an access request from a client, and to cause the cache device and the disk device to execute a process corresponding to the access request, wherein the storage control program makes a computer execute
a writing control including performing a control to write data, for which the client requested to write, into a predetermined number of cache devices from among the cache devices disposed on the network in a redundant manner; and
a reading control including performing, when data, for which the client requested to read, is not stored in any cache device from among the cache devices disposed on the network, controls to read the data from the disk device, to store the data-read in a specific cache device, and to transmit the data-read to the client.

14. The computer-readable recording medium according to claim 13, wherein the storage control program further makes the computer execute a cache control including performing, when the data written into the predetermined number of cache devices in the redundant manner is written into the disk, controls to cause a specific cache device from among the predetermined number of cache devices to maintain the data, and to cause other cache devices to free a memory area for the data.

15. The computer-readable recording medium according to claim 13, wherein the writing control includes performing the control to write the data, for which the client requested to write, into two cache devices from among the cache devices disposed on the network in the redundant manner.

16. The computer-readable recording medium according to claim 13, wherein the writing control includes performing the control to write the data, for which the client requested to write, into all the cache devices disposed on the network in the redundant manner.

17. The computer-readable recording medium according to claim 13, wherein the writing control includes instructing the predetermined number of cache devices to transmit the predetermined number with a notification of completion of writing the data to the client.

18. The computer-readable recording medium according to claim 13, wherein the storage control program further makes the computer execute
storing correspondence between a logical location designated by the client, a memory location in a cache device, and a storing location in a disk device for an area to store data for which the client makes a request for an access; and
transferring, every time an update is performed for the correspondence stored at the storing, information on the update to other storage control apparatus disposed on the network.
